(19) United States
(12) Patent Application Publication
(10) Pub. No.: US 2004/0198591 A1
(43) Pub. Date: Oct. 7, 2004

(54) Polymer-bound catalyst for the enantioselective aldol or mannich reaction

(76) Inventors: Jens Wöltinger, Hanau (DE); Hans-Peter Krimmer, Kirchweidach (DE); Andreas Karau, Neustadt (DE)

Correspondence Address: Michael A Sanzo, Fitch Even Tabin & Flannery, Suite 401L, 1801 K Street N W, Washington, DC, 20006-1201, US

(21) Appl. No.: 10/475,753

(22) PCT Filed: Mar. 20, 2002
(86) PCT No.: PCT/EP02/03051

(30) Foreign Application Priority Data
Apr. 26, 2001 (DE) 101 20 456.6

(51) Int. Cl. B01J 31/00

(52) U.S. Cl. 502/159

(57) ABSTRACT

The invention relates to catalysts for the enantioselective aldol or Mannich reaction. Said catalysts have an increased molecular weight by being bound to a polymer and as active units that enantioselectively catalyse the aldol or Mannich reaction comprise a compound of general formula (I). The invention also relates to a method for the production and use of said catalysts.

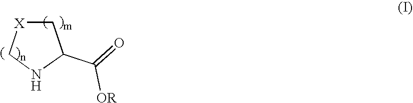

The present invention is directed to a catalyst for the enantioselective aldol reaction or Mannich reaction. In particular the invention relates to catalysts which on the one hand have an increased molecular weight by bonding to a polymer and which on the other hand have an amino acid as active unit for the enantioselective catalysis of the aldol or Mannich reaction. In particular compounds of the general formula (I) are intended in this connection.

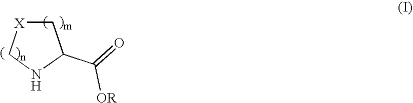

Polymer-enlarged chiral catalysts are important auxiliaries in the synthesis of enantiomer-enriched organic compounds particularly also on a technical scale, and at the same time on account of their catalytic activity on the one hand and their ability to be recycled and reused on the other hand, are able to effect the production of the desired products in an extremely cost-effective manner.

Numerous catalysts, including chiral catalysts, for the asymmetric aldol or Mannich reaction have been described in the literature. Some of these also relate to polymer-enlarged Lewis acids, which can be used in the so-called Mukaiyama reaction. The yields and ee values obtained thereby are however in some cases significantly less than those of the monomerically catalyst variant (A. Mandoli et al., Tetrahedron: Asymmetry 1998, 9, 1479f).

The suitability of proline for the enantioselective catalysis of aldol and Mannich reactions is fairly well known from the prior art (List et al. J. Am. Chem. Soc. 2000, 122, 9336f; ibid, 2000, 122, 2395; Hajos et al. 1974, 39, 1615f.; Wiechert et al. Angew. Chem., Int. Ed. Engl. 1971, 10, 496). The successful use of such polymer-enlarged catalysts has not hitherto been reported.

There is therefore also a need for polymer-enlarged catalysts for use in the organic catalytic aldol and Mannich reaction for the synthesis of chiral compounds.

The object of the present invention was accordingly to provide further polymer-enlarged catalysts that are able to catalyse the enantioselective aldol and Mannich reaction.

This object is achieved by the invention with the features of the present claim 1. Advantageous modifications of the invention are protected in the subclaims dependent on claim 1. Claim 7 relates to a preferred production process and claims 8 to 10 refer to the use of the catalysts according to the invention.

By providing polymer-enlarged catalysts comprising as active unit resulting in the chiral induction one or more of the structures of the general formula (I)

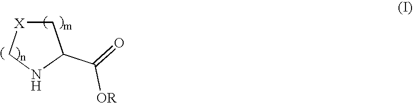

wherein

m, n independently of one another denote 0, 1, 2, 3, 4

X denotes CH₂, O, S, N, CHO, CHNH, CHS,

R denotes H, (C₁-C₈)-alkyl, (C₃-C₈)-cycloalkyl, (C₆-C₁₈)-aryl, (C₇-C₁₉)-aralkyl, it is possible to use these in catalytically operating processes, whereby the desired products may be obtained in outstanding yields and with high enantiomer excesses. Due to the polymer bonding the catalysts can be separated extremely efficiently, for example by filtration, from the low molecular weight compounds and are thereby accessible to the extremely simple but by no means less advantageous recycling desired according to the invention.

Furthermore, preferred compounds of the general formula (I) are those in which n=2 and m=1, X denoting an oxygen atom.

Particularly preferred is a catalyst according to the invention in which the active unit resulting in the chiral induction comprises one or more of the structures of the general formula (II)

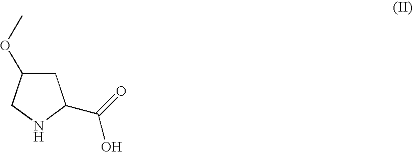

wherein the free valency on the alcohol oxygen atom symbolises the bonding to a polymer.

Polymer Enlargement:

The polymer enlargement may be freely chosen within the scope of the invention. The enlargement is restricted on the one hand by considerations of practicability and cost, and on the other hand by technical boundary conditions (retention capacity, solubility, etc.). Some polymer enlargements for catalysts are known from the prior art (Reetz et al., Angew. Chem. 1997, 109, 1559f.; Seebach et al., Helv. Chim. Acta 1996, 79, 1710f.; Kragl et al., Angew. Chem. 1996, 108, 684f.; Schurig et al., Chem. Ber./Recueil 1997, 130, 879f.; Bolm et al., Angew. Chem. 1997, 109, 773f.; Bolm et al. Eur. J. Org. Chem. 1998, 21f.; Baystone et al. in Speciality Chemicals 224f.; Salvalori et al., Tetrahedron: Asymmetry 1998, 9, 1479; Wandrey et al., Tetrahedron: Asymmetry. 1997, 8, 1529f.; ibid. 1997, 8, 1975f.; Togni et al., J. Am. Chem. Soc. 1998, 120, 10274f., Salvadori et al., Tetrahedron Lett. 1996, 37, 3375f; WO.98/22415; especially DE 19910691.6; Janda et al., J. Am. Chem. Soc. 1998, 120, 9481f.; Andersson et al., Chem. Commun. 1996, 1135f.; Janda et al., Soluble Polymers 1999, 1, 1; Janda et al., Chem. Rev. 1997, 97, 489;Geckler et al., Adv. Polym. Sci. 1995, 121, 31; White et al., in “The Chemistry of Organic Silicon Compounds” Wiley, Chichester, 1989, 1289; Schuberth et al., Macromol. Rapid Commun. 1998, 19, 309; Sharma et al., Synthesis 1997, 1217; “Functional Polymers” Ed.: R. Arshady, ASC, Washington, 1996; “Praktikum der Makromolekularen Stoffe”, D. Braun et al., VCH-Wiley, Weinheim 1999).

The polymer enlargement is preferably effected by polyacrylates, polyacrylamides, polyvinylpyrrolidinones, polysiloxanes, polybutadienes, polyisoprenes, polyalkanes, polystyrenes, polyoxazolines or polyethers, or mixtures thereof. In a most particularly preferred modification polystyrenes are used for effecting the polymer enlargement.

Linkers:

A linker may be incorporated between the actual active unit and the polymer enlargement. The linker serves to create an interspacing between the active unit and polymer in order to lessen or exclude interactions that are disadvantageous for the reaction.

The linkers may in principle be freely chosen by the person skilled in the art. They should be chosen according to how well they can be coupled on the one hand to the polymer/monomer, and on the other hand to the active centre. Suitable linkers may be found inter alia from the literature sources cited above under the heading “polymer enlargement”.

Within the scope of the invention these active units of the formulae (I) and (II) are advantageously, i.e. directly or preferably, bonded to the polymer enlargement by means of a linker selected from the following group

a) —Si (R₂)—

b) —(SiR₂—O)ₙ— n=1-10000

C) —(CHR—CHR—O)ₙ— n=1-10000

d) —(X)ₙ— n=1-20

e) Z-(X)ₙ— n=0-20

f) —(X)ₙ—W n=0-20

g) Z-(X)ₙ—W n=0-20

wherein

R denotes H, (C₁-C₈)-alkyl, (C₆-C₁₈)-aryl, (C₇-C₁₉)-aralkyl, ((C₁-C₈)-alkyl)₁₋₃-(C₆-C₁₈)-aryl,

X denotes C₆-C₁₈)-arylene, (C₁-C₈)-alkylene, (C₁-C₈)-alkenylene, ((C₁-C₈)-alkyl)₁₋₃-(C₆-C₁₈)-arylene, (C₇-C₁₉)-aralkylene,

Z, W denote independently of one another —C(═O)O—, —C(═O)NH—, —C(═O)—, NR, O, CHR, CH₂, C═S, S, PR.

Further preferred compounds that may be used as linkers are shown in the following diagram:

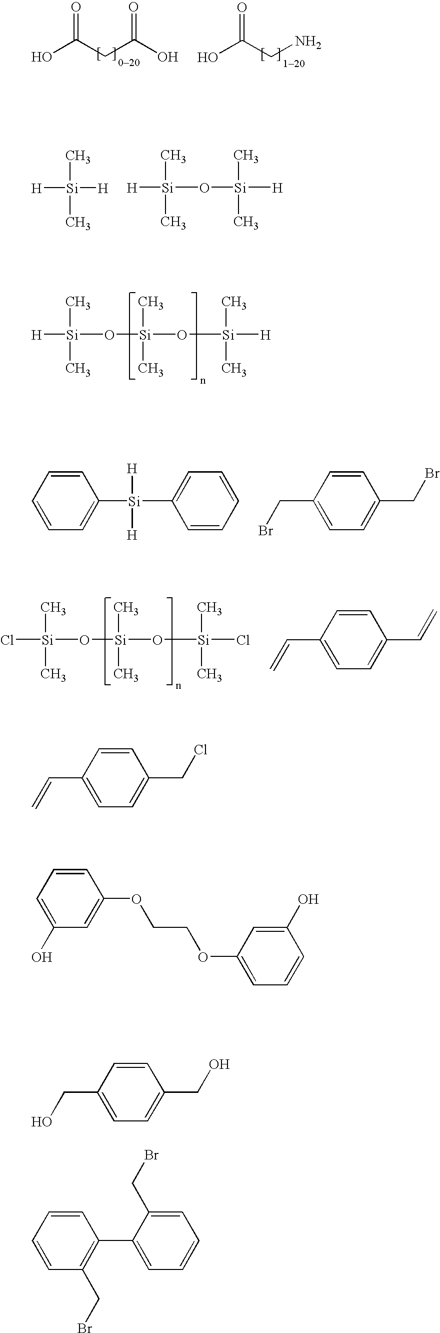

Most particularly preferred however are linkers such as for example 1,4′-biphenyl, 1,2-ethylene, 1,3-propylene, PEG-(2-10), α,ω-siloxanylene or 1,4-phenylene as well as α,ω-1,4-bisethylenebenzene or linkers that are obtainable starting from siloxanes of the general formula IV

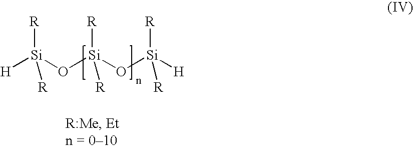

These can readily bond under hydrosilylation conditions (review of the hydrosilylation reaction of Ojima in The Chemistry of Organic Silicon Compounds, 1989 John Wiley & Sons Ltd., 1480-1526) to double bonds possibly present in the polymers and to suitable functional groups of the active centres.

The size of the polymer enlargement should be dimensioned so that the catalyst dissolves in the solvent to be used, i.e. so that the reaction can also be carried out in the homogeneous phase. The catalyst used according to the invention is therefore preferably an homogeneously soluble catalyst. In this way negative effects that occur due to the phase changes of the substrates and products that are otherwise necessary when using heterogeneous catalysts can be avoided.

The polymer-enlarged catalysts may have a mean molecular weight in the range from 1000 to 1,000,000 g/mole, preferably 5000 to 500,000. g/mole and particularly preferably 5000 to 300,000 g/mole.

Within the scope of the invention and on the basis of the specialist knowledge of a person skilled in the art, the aforementioned constituents of the polymer-enlarged catalysts (I) (polymer, linker, active centre/unit) can be combined arbitrarily having regard to optimum reaction conditions.

Combination of Polymer Enlargement and Linker/Active Unit:

In principle there are two possible ways by which the linker/active unit can be involved in the polymer enlargement:

a) the active unit resulting in the chiral induction is bound via a connected linker or directly to a monomer and this is copolymerised with further unmodified monomers, or

b) the active unit resulting in the chiral induction is bound via a linker or directly to the finished polymer.

Optionally polymers may be produced according to a) or b) and then block-copolymerised with other polymers that likewise contain the active units resulting in the chiral induction or do not contain such units.

Furthermore, it is true in principle as regards the number of linkers/active units per monomer in the polymer that as many such catalytically active units as possible should be available on a polymer so that the conversion per polymer is thereby increased. On the other hand the units should however adopt such an interspacing that a mutual negative influencing of the reactivity (TOF (turnover frequency), selectivity) is minimized or indeed is prevented. Preferably the mutual interspacing of the linkers/active centres in the polymer should therefore be in the range from 1 to 200 monomer units, preferably 5 to 25 monomer units.

In an advantageous modification those sites in the polymer or monomer to be polymerised are involved in the bonding of the linker/active unit that can easily be functionalised or that already enable an existing functionality to be used for the bonding. Thus, heteroatoms or unsaturated carbon atoms are ideally suitable for effecting the bonding.

For example, in the case of styrene/polystyrene the existing aromatic compounds may be used as binding sites to the linkers/active units. Functional groups may readily be coupled by normal aromatic chemistry techniques to these aromatic compounds, preferably in the 3-, 4- or 5-position, particularly preferably in the 4-position. It is however also advantageous to mix for example already functionalised monomer with the mixture to be polymerised, and after the polymerisation to bind the linker to the, functional groups present in the polystyrene. Advantageously, p-hydroxystyrene, p-chloromethylstyrene or p-aminostyrene derivatives are for example suitable for this purpose.

In the case of polyacrylates an acidic group or ester group is in each case present in the monomer constituent, to which the linker or the active unit can be bound, preferably via an ester bond or amide bond, either before or after the polymerisation.

Polysiloxanes as agents for increasing the molecular weight (polymer enlargement) are preferably identically constructed so that, in addition to dimethylsilane units, hydroxymethylsilane units are also present. The linkers/active units may then in turn be coupled to these sites via an hydrosilylation reaction. Preferably these can bond under hydrosilylation conditions (review of the hydrosilylation reaction of Ojima in “The Chemistry of Organic Silicon Compounds”, 1989, John Wiley & Sons Ltd., 1480-1526) to the envisaged functional groups in the polymer.

Suitable polysiloxanes modified in this way are known in the literature (“Siloxane polymers and copolymers”, White et, al., in Ed. S. Patai “The Chemistry of Organic Silicon Compounds”, Wiley, Chichester, 1989, 46, 2954; C. Wandrey et al. TH: Asymmetry 1997, 8, 1975).

Combination of Linker/Polymer and Active Unit:

For the active units according to the invention the polymer-enlargement bonding is optionally carried out via the linker and preferably via the ring, though obviously a free nitrogen function in the 1-position and a free acid group are essential for the successful conversion of the substrates (List et al. J. Am. Chem. Soc. 2000, 122, 9336f;. ibid. 2000, 122, 2395; Hajos et al. 1974, 39, 1615f.).

In the case of a carbocyclic ring the bonding is preferably carried out via a C—C coupling, and preferably sufficiently far from the bonding sites essential for the reaction as to prevent any negative influences on the reaction itself. If a further nitrogen atom is present in the carbon ring, then it is most particularly preferred to effect the bonding to the polymer/linker via this triple bond nitrogen atom. In the case where a CHS— or CHO— or CHNH— function is present, the bonding to the polymer/linker may be successfully and simply carried out via the heteroatoms themselves.

In the case of the compound (II) as active unit its bonding to the polymer enlargement is most particularly preferably effected via the free hydroxyl group. The starting material for this purpose—hydroxyproline—is commercially available in an enantiomer-enriched form and may therefore readily be synthesised onto the polymer enlargement via an ether or ester bond.

In another modification the invention is directed to the use of the catalyst according to the invention for the enantioselective aldol or Mannich reaction, in particular in homogeneous phase. The procedures described in the literature are employed for this purpose (e.g. List et al., JACS, 2000, 9336 and List et al., JACS, 2000, 2395). In order to achieve a short reaction time (<5 hours; a reaction time of 1 hour is preferred in order to obtain a quantitative conversion with high ee), the reaction should be carried out with a catalyst demand of up to 20 equivalents.

The reaction according to the invention is therefore preferably carried out in a membrane reactor. The procedure in this apparatus, which may take place continuously apart from in a batchwise and semi-continuous manner, may be carried out as desired in crossflow filtration mode (FIG. 2) or as dead-end filtration (FIG. 1). Both methods involve an in situ recycling of the catalyst, which means that they can be carried out economically despite the high catalyst demand. Both process variants are in principle described in the prior art (Engineering Processes for Bioseparations, Ed.: L. R. Weatherley, Heinemann, 1994, 135-165; Wandrey et al., Tetrahedron Asymmetry 1999, 10, 923-928).

The catalyst can be used particularly preferably for the production of bioactive substances.

### DESCRIPTION OF THE DRAWINGS

FIG. 1 shows a membrane reactor with dead-end filtration. The substrate 1 is transferred via a pump 2 to the reactor space 3, which comprises a membrane 5. The stirrer-operated reactor space includes, in addition to the solvent, the catalyst 4, the product 6 and unreacted substrate 1. Mainly low molecular weight product 6 is filtered off through the membrane 5.

FIG. 2 shows a membrane reactor with crossflow filtration. The substrate 7 is in this case transferred via the pump 8 to the stirred reactor space, which also contains solvent, catalyst 9 and product 14. By means of the pump 16 a solvent flow is established that passes through an optionally present heat exchanger 12 into the crossflow filtration cell 15. Here the low molecular weight, product 14 is separated via the membrane 13. High molecular weight catalyst 9 is then recycled together with the solvent flow optionally through a heat exchanger 12 and optionally through the valve 11 back into the reactor 10.

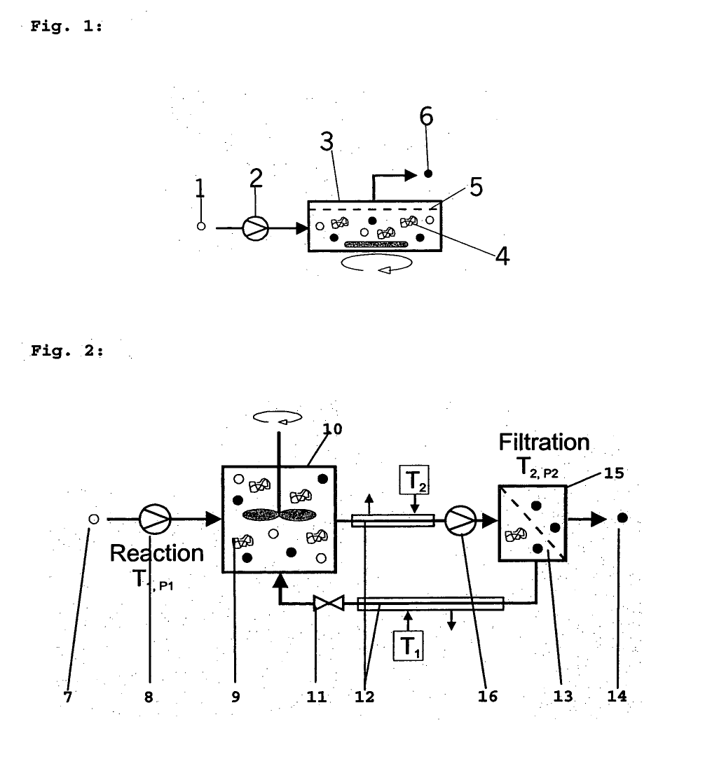

Mixtures of polymer-enlarged polymers are understood within the scope of the invention to mean that individual polymers of different origin are polymerised together; to form block polymers. Random mixtures of the monomers in the polymer are also possible.

Polymer enlargement is understood within the scope of the invention to mean that one or more active units resulting in the chiral induction are copolymerised in a form suitable for this purpose with further monomers, or that this unit/these units are coupled to a polymer already present according to methods known to the person skilled in the art. Types of units suitable for the copolymerisation are well known to the person skilled in the art and can be freely chosen by the latter. The preferred procedure is, depending on the nature of the copolymerisation, to derivatise the molecule in question with groups capable of undergoing copolymerisation, for example in the case of copolymerisation with (meth) acrylates by coupling to acrylate molecules.

As (C₁-C₈)-alkyl there may be used methyl, ethyl, n-propyl, isopropyl, n-butyl, isobutyl, sec-butyl, tert-butyl, pentyl, hexyl; heptyl or octyl, as well as all bond isomers.

A (C₆-C₁₈)-aryl radical is understood to denote an aromatic radical with 6 to 18 C atoms. In particular this includes compounds such as phenyl, naphthyl, anthryl, phenanthryl and biphenyl radicals. These may be singly or multiply substituted with (C₁-C₈)-alkoxy, (C₁-C₈)-haloalkyl, OH, Cl, NH₂ or NO₂. Also the radical may comprise one or more heteroatoms such as N, O, S.

(C₁-C₈)-alkoxy is a (C₁-C₈)-alkyl radical bonded via an oxygen atom to the molecule in question.

A (C₇-C₁₉)-aralkyl radical is a (C₆-C₁₈)-aryl radical bonded via a (C₁-C₈)-alkyl radical to the molecule.

The term acrylate is understood within the scope of the invention to include also the term methacrylate.

(C₁-C₈)-haloalkyl denotes a (C₁-C₈)-alkyl radical substituted with one or more halogen atoms. Suitable halogen atoms are in particular chlorine and fluorine.

A (C₃-C₁₈)-heteroaryl radical denotes within the scope of the invention a 5-membered, 6-membered or 7-membered aromatic ring system containing 3 to 18 C atoms that comprises heteroatoms such as for example nitrogen, oxygen or sulfur in the ring. Heteroaromatic radicals are in particular radicals such as 1-, 2-, 3-furyl, such as 1-, 2-, 3-pyrrolyl, 1-, 2-, 3-thienyl, 2-, 3-, 4-pyridyl, 2-, 3-, 4-, 5-, 6-, 7-indolyl, 3-, 4-, 5-pyrazolyl, 2-, 4-, 5-imidazolyl, imidazolyl, acridinyl, quinolinyl, phenanthridinyl or 2-, 4-, 5-, 6-pyrimidinyl. This may be singly or multiply substituted with (C₁-C₈)-alkoxy, (C₁-C₈)-haloalkyl, OH, halogen, NH₂, NO₂, SH, S—(C₁-C₈)-alkyl.

A (C₄-C₁₉)-heteroaralkyl is understood to denote an heteroaromatic system corresponding to the (C₇-C₁₉)-aralkyl radical.

The term (C₁-C₈)-alkylene chain is understood to denote a (C₁-C₈)-alkyl radical that is bonded via two different C atoms to the relevant molecule. This may be singly or multiply substituted with (C₁-C₈)-alkoxy, (C₁-C₈)-haloalkyl, OH, halogen, NH₂, NO₂, SH, S—(C₁-C₈)-alkyl.

(C₃-C₈)-cycloalkyl is understood to denote cyclopropyl, cyclobutyl, cyclopentyl, cyclohexyl, cycloheptyl or cyclooctyl radicals.

Halogen is fluorine, chlorine, bromine or iodine.

Within the scope of the invention the term membrane reactor is understood to mean any reaction vessel in which the catalyst is enclosed in a reactor, while low molecular weight substances can be added to the reactor or can leave the latter. In this connection the membrane may be integrated directly into the reaction space or may be incorporated outside in a separate filtration module, in which the reaction flows continuously or intermittently through the filtration module and the retentate is recycled to the reactor. Suitable embodiments are described inter alia in WO98/22415 and in Wandrey et al. in the 1998 Yearbook, Verfahrenstechnik und Chemieingenieurwesen, VDI p. 151ff.; Wandrey et al. in Applied Homogeneous Catalysis with Organometallic Compounds, Vol. 2, VCH 1996, p. 832ff.; Kragl et al., Angew. Chem. 1996, 6, 684f.

The illustrated chemical structures refer to all possible stereoisomers that can be obtained by altering the configuration of the individual chiral centres, axes or planes, i.e. all possible diastereomers, as well as all optical isomers covered by the latter (enantiomers). It should however be pointed out that, within a polymer-enlarged catalyst, all active units present should according to the invention have the same chirality.

1-10. (canceled)

11. A polymer-enlarged catalyst comprising:
a) an active unit of the general formula (I): 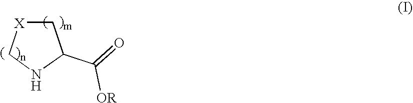
wherein
m and n are each independently selected from 0, 1, 2, 3, or 4;
X is selected from CH₂, O, N, S, CHO, CHNH, or CHSH;
R is selected from H, (C₁-C₈)-alkyl, (C₃-C₈)-cycloalkyl, (C₆-C₁₈)-aryl, (C₇-C₁₉)-aralkyl; and
at least one polymer bound to said active unit and selected from the group consisting of: polyacrylates, polyacrylamides, polyvinylpyrrol-idinones, polysiloxanes, polybutadienes, polyisoprenes, polyalkanes, polystyrenes, and polyoxazolines, or mixtures thereof.

12. The catalyst of claim 11, wherein said active unit is of the general formula (II): 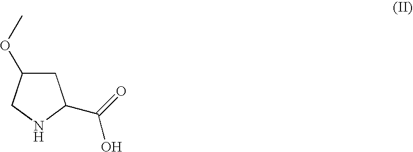
wherein the free valency on the alcohol oxygen atom symbolises bonding to a polymer.

13. The catalyst of either claim 11 or claim 12, further comprising a linker joining said polymer to said active unit, wherein said linker is selected from the group consisting of:
a) —Si(R₂)—;
b) —(SiR₂—O)ₙ— n=1-10000;
c) —(CHR—CHR—O)ₙ— n=1-10000;
d) —(X)ₙ— n=1-20;
e) Z-(X)ₙ— n=0-20;
f) —(X)ₙ—W n=0-20;
g) Z-(X)ₙ—W n=0-20;
wherein
R is selected from H, (C₁-C₈)-alkyl, (C₆-C₁₈)-aryl, (C₇-C₁₉)-aralkyl, ((C₁-C₈)-alkyl)₁₋₃-(C₆-C₁₈)-aryl;
X is selected from (C₆-C₁₈)-arylene, (C₁-C₈)-alkylene, (C₁-C₈)-alkenylene, ((C₁-C₈)-alkyl)₁₋₃-(C₆-C₁₈)-arylene, (C₇-C₁₉)-aralkylene;
Z and W are each independently selected from: —C(═O)O—, —C(═O)NH—, —C(═O)—, NR, O, CHR, CH₂, C═S, S, PR.

14. The catalyst of either claim 11 or claim 12, wherein said catalyst is homogeneously soluble.

15. The catalyst of either claim 11 or claim 12, wherein the mean molecular weight of said catalyst is between 5,000 and 300,000 g/mole.

16. A process for the production of a catalyst according to claim 11, comprising binding said active unit to a linker bound to a monomer or directly to a monomer and then copolymerizing the product form with other unmodified monomers.

17. A process for the production of a catalyst according to claim 11, comprising binding said active unit via a linker or directly to the finished polymer.

18. A process for the production of a catalyst according to claim 11, comprising forming polymers according to either claim 16 or claim 17 and then block copolymerizing these polymers with other polymers that may optionally also comprise active units.

19. In a process for performing the enantioselective aldol reaction or the mannich reaction, the improvement comprising catalyzing said reaction with the catalyst of either claim 11 or claim 12.

20. In a process for performing the enantioselective aldol reaction or the mannich reaction, the improvement comprising catalyzing said reaction with the catalyst of claim 15.

21. The process of claim 19, wherein said process is carried out in a membrane reactor.
